(19) United States
(12) Patent Application Publication
(10) Pub. No.: US 2025/0203735 A1
(43) Pub. Date: Jun. 19, 2025

(54) ELECTRONIC DEVICE WITH DYNAMIC LIGHTING EFFECT AND METHOD FOR GENERATING DYNAMIC LIGHTING EFFECT

(71) Applicant: Acer Incorporated, New Taipei City (TW)

(72) Inventors: Kuan-Ju CHEN, New Taipei City (TW); Mei-Chun WU, New Taipei City (TW); Yu-Shan RUAN, New Taipei City (TW); Chi-Hau HUNG, New Taipei City (TW); Liang-Chi CHEN, New Taipei City (TW); Yu-Wei CHEN, New Taipei City (TW)

(73) Assignee: Acer Incorporated, New Taipei City (TW)

(21) Appl. No.: 18/917,481

(22) Filed: Oct. 16, 2024

(30) Foreign Application Priority Data
Dec. 13, 2023 (TW) 112148601

(51) Int. Cl. H05B 47/125; G06F 3/01; H05B 47/165

(52) U.S. Cl. CPC H05B 47/125; G06F 3/013; H05B 47/165

(57) ABSTRACT

An electronic device with dynamic lighting effect and a method for generating dynamic lighting effect are provided. The method for generating dynamic lighting effect includes the following steps. A lighting effect tracking frame is provided according to an eye position of a user, a dynamic lighting effect frame is received, or a predefined lighting effect frame is stored. The lighting effect tracking frame, the dynamic lighting effect frame or the predefined lighting effect frame is obtained. A size adjustment procedure is performed on the lighting effect tracking frame, the dynamic lighting effect frame or the predefined lighting effect frame to obtain a lighting effect control map. The dynamic lighting effect device is controlled according to the lighting effect control map to generate the dynamic lighting effect.

This application claims the benefit of Taiwan application Serial No. 112148601, filed Dec. 13, 2023, the subject matter of which is incorporated herein by reference.

### BACKGROUND OF THE INVENTION

### Field of the Invention

The invention relates in general to an electronic device, and more particularly to an electronic device with dynamic lighting effect and a method for generating dynamic lighting effect.

### Description of the Related Art

Conventional keyboard can only emit light in a fixed manner. However, the fixed light emitting method of the keyboard would appear to be boring and monotonous when the user is playing e-sports or running interactive programming with his/her computer. At the end, the user cannot have a satisfactory experience. Therefore, it has become a prominent task for the industries to enhance the lighting effect of the keyboard and improve the user's experience with the use of computer.

### SUMMARY OF THE INVENTION

The invention is directed to an electronic device with dynamic lighting effect and a method for generating dynamic lighting effect capable of providing various dynamic lighting effects and allowing the user to create a personalized keyboard by freely switch among a diversity of light colors and colorful lighting effects of the keyboard's backlights.

According to one embodiment of the present invention, an electronic device with dynamic lighting effect is provided. The electronic device with dynamic lighting effect includes an AI interactive unit, a self-defined lighting effect unit, a predefined lighting effect unit, a real-time lighting effect handler, a static lighting effect handler, a lighting effect applications interface unit, an HID control unit and a dynamic lighting effect device. The AI interactive unit is used to provide a lighting effect tracking frame according to an eye position of a user. The self-defined lighting effect unit is used to receive a dynamic lighting effect frame. The predefined lighting effect unit is used to store a predefined lighting effect frame. The real-time lighting effect handler is connected to the AI interactive unit and the self-defined lighting effect unit to obtain the lighting effect tracking frame or the dynamic lighting effect frame. The static lighting effect handler is connected to the predefined lighting effect unit to obtain the predefined lighting effect frame. The lighting effect runtime unit is connected to the real-time lighting effect handler and the static lighting effect handler. The lighting effect runtime unit is used to perform a size adjustment procedure on the lighting effect tracking frame, the dynamic lighting effect frame or the predefined lighting effect frame to obtain a lighting effect control map. The lighting effect applications interface unit is connected to the lighting effect runtime unit to obtain the lighting effect control map. The HID control unit is used to obtain the lighting effect control map from the lighting effect applications interface unit. The HID control unit output a control signal to the dynamic lighting effect device according to the lighting effect control map to generate the dynamic lighting effect.

According to another embodiment of the present invention, a method for generating dynamic lighting effect is provided. The method for generating dynamic lighting effect includes the following steps. A lighting effect tracking frame is provided according to an eye position of a user, a dynamic lighting effect frame is received, or a predefined lighting effect frame is stored. The lighting effect tracking frame, the dynamic lighting effect frame or the predefined lighting effect frame is obtained. A size adjustment procedure is performed on the lighting effect tracking frame, the dynamic lighting effect frame or the predefined lighting effect frame to obtain a lighting effect control map. The dynamic lighting effect device is controlled according to the lighting effect control map to generate the dynamic lighting effect.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an electronic device with dynamic lighting effect according to an embodiment of the present disclosure.

FIG. 2 is another schematic diagram of an electronic device with dynamic lighting effect according to an embodiment of the present disclosure.

FIG. 3 is another schematic diagram of an electronic device with dynamic lighting effect according to an embodiment of the present disclosure.

FIG. 4 is a block diagram of an electronic device with dynamic lighting effect according to an embodiment of the present disclosure.

FIG. 5 is a flowchart of a method for generating dynamic lighting effect according to an embodiment of the present disclosure.

FIG. 6 is a detailed flowchart of step S110 according to an embodiment of the present disclosure.

FIG. 7 is a detailed flowchart of step S110 according to another embodiment of the present disclosure.

FIG. 8 is a detailed flowchart of step S110 according to another embodiment of the present disclosure.

FIGS. 9A to 9B are a detailed flowchart of step S130 according to an embodiment of the present disclosure.

FIG. 10 illustrates each step of FIGS. 9A to 9B.

### DETAILED DESCRIPTION OF THE INVENTION

Technical terms are used in the specification with reference to the prior art used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present disclosure.

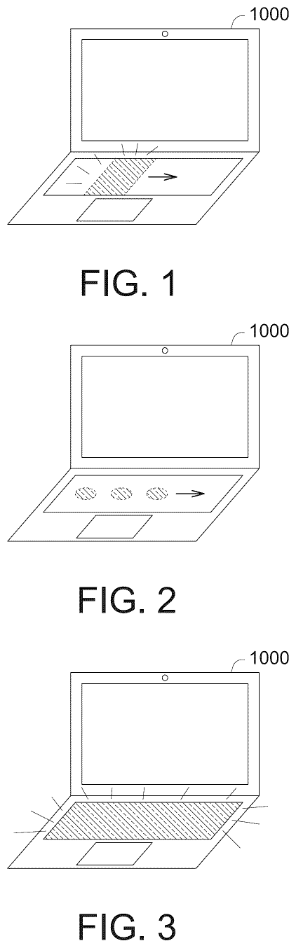

Referring to FIG. 1, a schematic diagram of an electronic device 1000 with dynamic lighting effect according to an embodiment of the present disclosure is shown. In the present embodiment, the electronic device 1000 can use a human eye tracking technique which synchronizes the dynamic lighting effect of the keyboard with the moving direction of the user's eyeballs.

Referring to FIG. 2, another schematic diagram of an electronic device 1000 with dynamic lighting effect according to an embodiment of the present disclosure is shown. In an embodiment, the user can input a particular dynamic frame according to personal preference, so that the lighting effect of the keyboard can display dynamic lighting effect according to the inputted dynamic frame when the electronic device 1000 is in use.

Referring to FIG. 3, another schematic diagram of an electronic device 1000 with dynamic lighting effect according to an embodiment of the present disclosure is shown. In another embodiment, the electronic device displays the dynamic lighting effect according to predetermined conditions and frames. For instance, when the user is playing a shooting game, the keyboard can automatically light up the backlight of all press keys with by red light spots to remind the player that the ammunition will soon run out of stock.

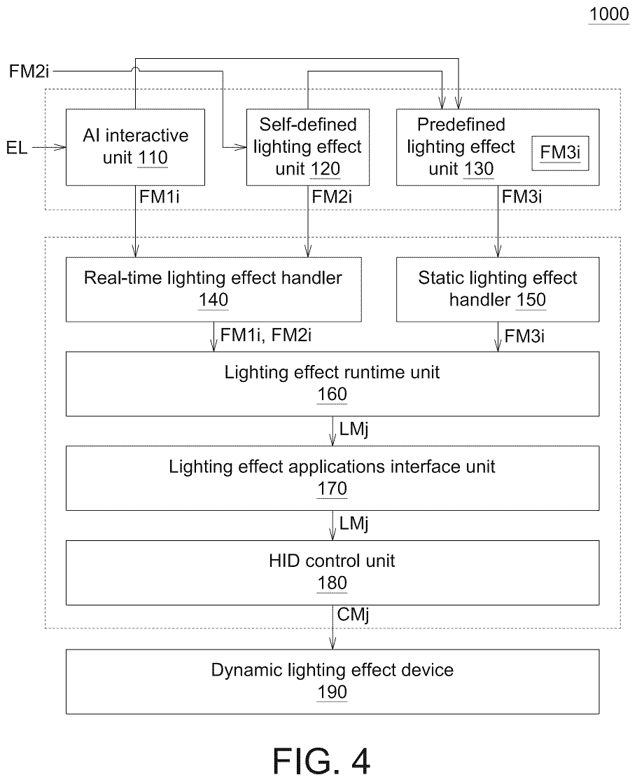

Referring to FIG. 4, a block diagram of according to an electronic device 1000 with dynamic lighting effect another embodiment of the present disclosure is shown. The electronic device 1000 with dynamic lighting effect includes an AI interactive unit 110, a self-defined lighting effect unit 120, a predefined lighting effect unit 130, a real-time lighting effect handler 140, a static lighting effect handler 150, a lighting effect runtime unit 160, a lighting effect applications interface unit 170, a human interface device (HID) control unit 180 and a dynamic lighting effect device 190.

The AI interactive unit 110, the self-defined lighting effect unit 120 and the predefined lighting effect unit 130 are used to provide various lighting effect frames. The real-time lighting effect handler 140 and the static lighting effect handler 150 are used to obtain the abovementioned lighting effect frames. The lighting effect runtime unit 160 and the lighting effect applications interface unit 170 are used to perform a conversion procedure on the abovementioned lighting effect frames, so that these frames can comply with the configuration of the dynamic lighting effect device 190. The HID control unit 180 is used to control the dynamic lighting effect device 190 to generate a dynamic lighting effect.

The self-defined lighting effect unit 120 can be realized by any type of data reception device, such as wireless transmission module or USB port.

The predefined lighting effect unit 130 can be realized by any type of fixed or portable random access memory (RAM), read-only memory (ROM), flash memory, hard disk drive (HDD), solid state drive (SSD) or similar element or a combination thereof, and is used to store multiple modules that can be executed by the processor or various application programs.

The AI interactive unit 110, the real-time lighting effect handler 140, the static lighting effect handler 150, the lighting effect runtime unit 160, the lighting effect applications interface unit 170 and the HID control unit 180 can be realized by a central processing unit (CPU), or other programmable general or specific purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), firmware or other similar element or a combination thereof.

The dynamic lighting effect device 190 can be realized by a keyboard backlight device, a casing light-emitting device or a mouse housing light-emitting device.

In the present embodiment, by using the above elements, the electronic device 1000 with dynamic lighting effect allows the user to switch among different modes according to personal preference to generate different keyboard lighting effects to satisfy the user's experience with the keyboard lighting effect. Operations of each element are disclosed below with accompanying flowcharts.

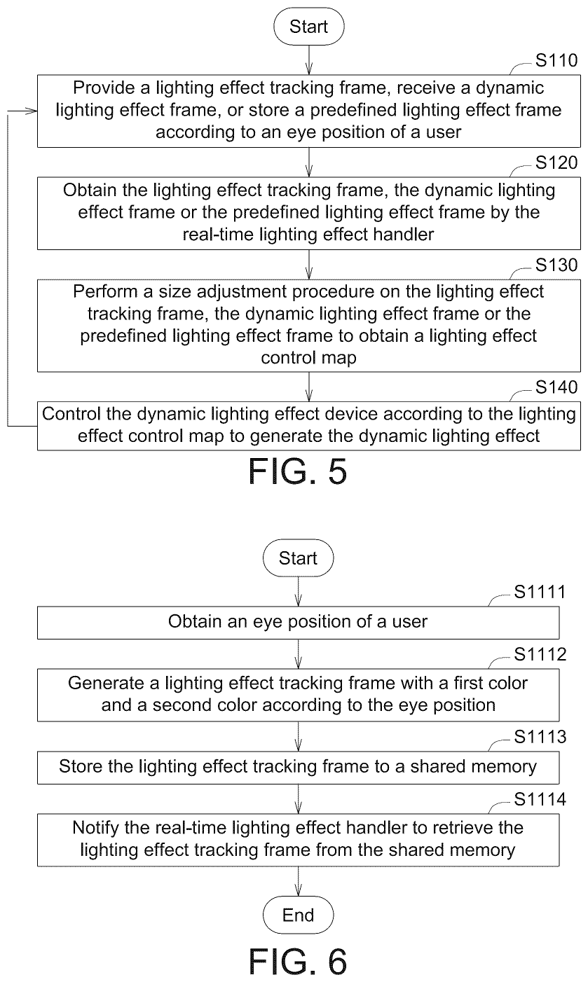

Referring to FIG. 5, a flowchart of a method for generating dynamic lighting effect according to an embodiment of the present disclosure is shown. The method for generating dynamic lighting effect includes steps S110 to S140. In step S110, a lighting effect tracking frame FM1i is provided by the AI interactive unit 110 according to an eye position EL of a user, the dynamic lighting effect frame FM2i is received by the self-defined lighting effect unit 120, or the predefined lighting effect frame FM3i is stored by the predefined lighting effect unit 130.

For instance, when the user moves his/her eyeballs to the left, the lighting direction of the lighting effect tracking frame FM1i will move to the left synchronically; when the user moves his/her eyeballs upwards, the lighting direction of the lighting effect tracking frame FM1i will synchronically move towards the monitor.

The dynamic lighting effect frame FM2i received by the self-defined lighting effect unit 120 can be continuous dynamic frames inputted the user based on personal preference.

The predefined lighting effect frame FM3i stored by the predefined lighting effect unit 130 can be a predetermined static frame or dynamic frame corresponding to a particular condition.

The electronic device with dynamic lighting effect can provide only one rather than all of the lighting effect tracking frame FM1i, the dynamic lighting effect frame FM2i, and the predefined lighting effect frame FM3i. The lighting effect tracking frame FM1i and the dynamic lighting effect frame FM2i disclosed above are real-time frames; the predefined lighting effect frame FM3i is a predetermined frame.

Then, the method proceeds to step S120, the lighting effect tracking frame FM1i is obtained by the real-time lighting effect handler 140, the dynamic lighting effect frame FM2i is obtained by the real-time lighting effect handler 140, or the predefined lighting effect frame FM3i is obtained by the static lighting effect handler 150. In the present step, it is possible that only one of the lighting effect tracking frame FM1i, the dynamic lighting effect frame FM2i, and the predefined lighting effect frame FM3i is obtained.

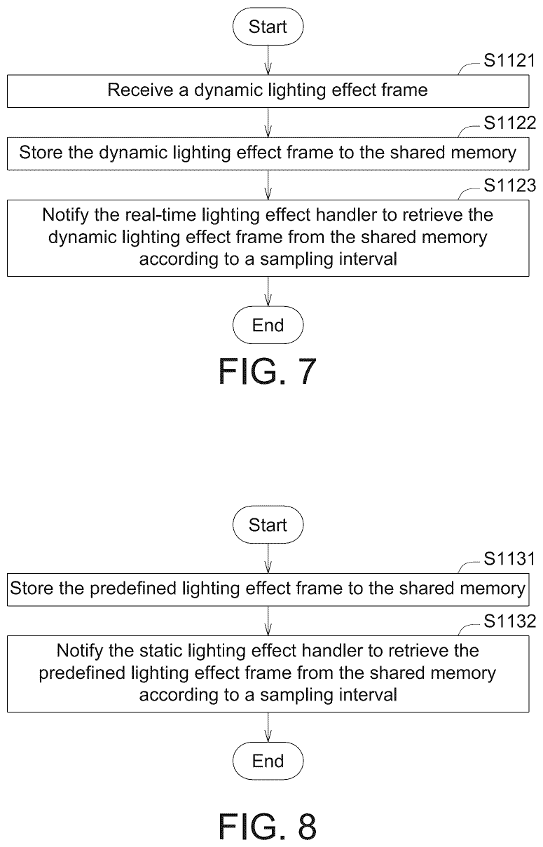

The real-time lighting effect handler 140 is concurrently connected to the AI interactive unit 110 and the self-defined lighting effect unit 120 and is used to receive the lighting effect tracking frame FM1i from the AI interactive unit 110, or the self-defined lighting effect unit 120 receives the dynamic lighting effect frame FM2i. The static lighting effect handler 150 is connected to the predefined lighting effect unit 130 to obtain the predefined lighting effect frame FM3i from the predefined lighting effect unit 130. The lighting effect tracking frame FM1i varies dynamically along with the human eyes; details of the method for providing and obtaining the lighting effect tracking frame FM1i are illustrated in FIG. 6. The dynamic lighting effect frame FM2i varies dynamically along with the time; details of the method for providing and obtaining the dynamic lighting effect frame FM2i are illustrated in FIG. 7. The predefined lighting effect frame FM3i is a predetermined frame; details of the method for providing and obtaining the predefined lighting effect frame FM3i are illustrated in FIG. 8.

Then, the method proceeds to step S130, a size adjustment procedure is performed on the lighting effect tracking frame FM1i, the dynamic lighting effect frame FM2i, or the predefined lighting effect frame FM3i by the lighting effect runtime unit 160 to obtain a lighting effect control map LMj.

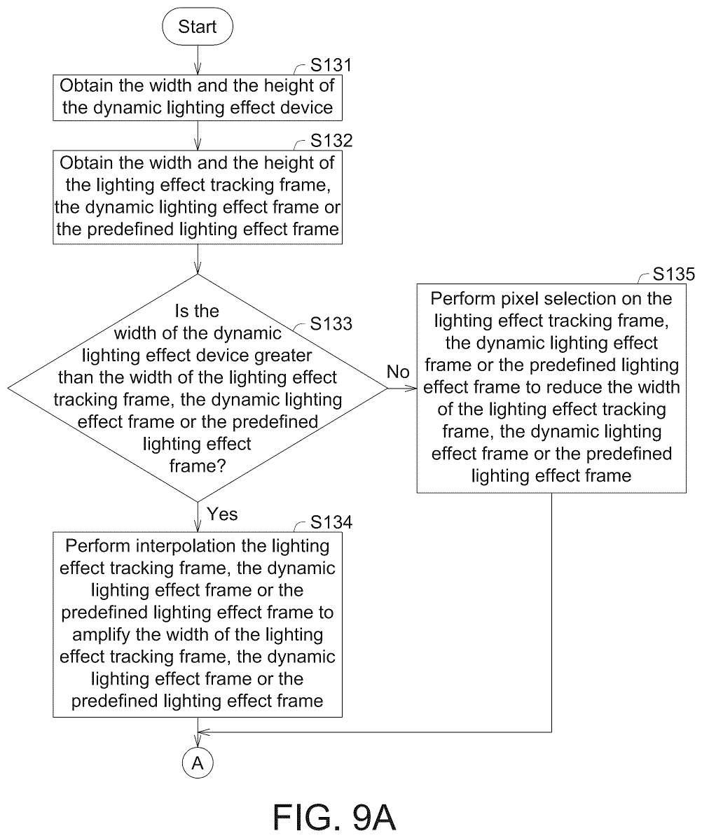

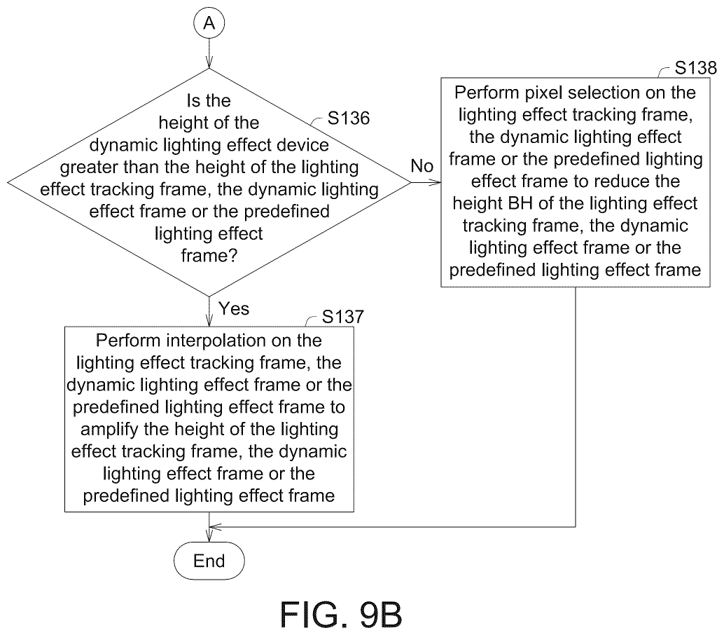

In step S130, a width adjustment procedure and a height adjustment procedure are performed on the lighting effect tracking frame FM1i, the dynamic lighting effect frame FM2i or the predefined lighting effect frame FM3i by the lighting effect runtime unit 160. Detailed steps of the size adjustment procedure are illustrated in FIGS. 9A to 9B.

Then, the method proceeds to step S140, the dynamic lighting effect device 190 is controlled by the dynamic lighting effect device 190 according to the lighting effect control map LMj to generate the dynamic lighting effect. In the present step, the lighting effect control map LMj is obtained from the lighting effect runtime unit 160 by the lighting effect applications interface unit 170. Then, after the lighting effect control map LMj is obtained from the lighting effect applications interface unit 170, the HID control unit 180 outputs a control signal CMj to the dynamic lighting effect device 190 according to the lighting effect control map LMj to control the dynamic lighting effect device 190 to generate a corresponding dynamic lighting effect.

In the above embodiment, the electronic device 1000 with dynamic lighting effect can generate various dynamic lighting effects according to the user's preference, so that the user can have better experience with the keyboard. Details of each step are disclosed below.

Referring to FIG. 6, a detailed flowchart of step S110 according to an embodiment of the present disclosure is shown. According to the above embodiments, step S110 includes steps S1111 to S1114. In step S1111, an eye position EL of a user is obtained by the AI interactive unit 110. The AI interactive unit 110 can real-time recognize the image in front of the electronic device 1000 using a human eyes recognition mode to recognize the human eyes, and track the eye position EL.

Then, the method proceeds to step S1112, a lighting effect tracking frame FM1i with a first color and a second color is generated by the AI interactive unit 110 according to the eye position EL. The first color and the second color are two colors, such as red and blue, forming a sharp contrast. The first color corresponds to the eye position EL. When the eye position EL moves, the first color can perform a corresponding movement in response to the moving direction of the eye position EL.

In step S1113, the lighting effect tracking frame FM1i is stored to a shared memory by the AI interactive unit 110. The shared memory can be realized by any type of fixed or portable random access memory (RAM), read-only memory (ROM), flash memory, hard disk drive (HDD), solid state drive (SSD) or similar element or a combination thereof. In an embodiment, the AI interactive unit 110 detects the eye position EL at any time, but updates and stores the lighting effect tracking frame FM1i only when the eye position EL moves. The newly stored lighting effect tracking frame FM1i will replace the originally stored lighting effect tracking frame FM1i.

In step S1114, the real-time lighting effect handler 140 is notified by the AI interactive unit 110 to retrieve the lighting effect tracking frame FM1i from the shared memory. In an embodiment, the AI interactive unit 110 detects the eye position EL at any time, but notifies the real-time lighting effect handler 140 to retrieve the lighting effect tracking frame FM1i from the shared memory only when the eye position EL moves.

Next, the method proceeds to subsequent steps S120 to S140 to generate a corresponding dynamic lighting effect. Details of steps S120 to S140 are already disclosed above and will not be repeated here. In the present embodiment, a human eyes tracking technique is used, and when the eye position EL moves, the dynamic lighting effect of the keyboard is moved correspondingly in response to the moving direction of the eye position EL.

Referring to FIG. 7, a detailed flowchart of step S110 according to another embodiment of the present disclosure is shown. In another embodiment, detailed process of step S110 includes steps S1121 to S1123. In step S1121, a dynamic lighting effect frame FM2i is received by the self-defined lighting effect unit 120. The dynamic lighting effect frame FM2i is a dynamic frame inputted by the. The self-defined lighting effect unit 120 real-timely receives the dynamic lighting effect frame FM2i, such as a dynamic frame obtained from the Internet in real time.

Then, the method proceeds to step S1122, the dynamic lighting effect frame FM2i is stored to the shared memory by the self-defined lighting effect unit 120. Since the dynamic lighting effect frame FM2i is obtained in real time, the self-defined lighting effect unit 120 real-timely and periodically stores the dynamic lighting effect frame FM2i to the shared memory in order. The newly stored dynamic lighting effect frame FM2i will replace the originally stored dynamic lighting effect frame FM2i.

Then, the method proceeds to step S1123, the real-time lighting effect handler 140 is notified by the self-defined lighting effect unit 120 to retrieve the dynamic lighting effect frame FM2i from the shared memory according to a sampling interval. The sampling interval is such as an interval at which the above frame is stored to the shared memory. Based on the sampling interval, the real-time lighting effect handler 140 can smoothly obtain the dynamic lighting effect frame FM2i stored to the shared memory in each cycle.

Then, the method proceeds to subsequent steps S120 to S140 to generate a corresponding dynamic lighting effect. Details of step S120 to S140 are already disclosed above and will not be repeated here. Therefore, in the present embodiment, the lighting effect of the keyboard can display different dynamic lighting effects in real time according to the dynamic frame real-timely inputted by the user.

Referring to FIG. 8, a detailed flowchart of step S110 according to another embodiment of the present disclosure. In another embodiment, step S110 detailed process of includes step S1131 to S1132. In step S1131, the predefined lighting effect frame FM3i is stored to the shared memory by the predefined lighting effect unit 130. The predefined lighting effect frame FM3i is such as a single static or dynamic frame with fixed length. In the present embodiment, the predefined lighting effect frame FM3i corresponds to a particular predetermined condition.

In step S1132, the static lighting effect handler 150 is notified by the predefined lighting effect unit 130 to retrieve the predefined lighting effect frame FM3i from the shared memory according to a sampling interval. Each time when the static lighting effect handler 150 retrieves the predefined lighting effect frame FM3i from the shared memory, the static lighting effect handler 150 sequentially and periodically retrieves the predefined lighting effect frame FM3i according to the predetermined position.

Next, the method proceeds to subsequent steps S120 to S140 to generate a corresponding dynamic lighting effect. Details of step S120 to S140 are already disclosed above and will not be repeated here. In the present embodiment, the keyboard displays the lighting effect according to predetermined conditions, and will display the predetermined static or dynamic lighting effect when the corresponding condition is met.

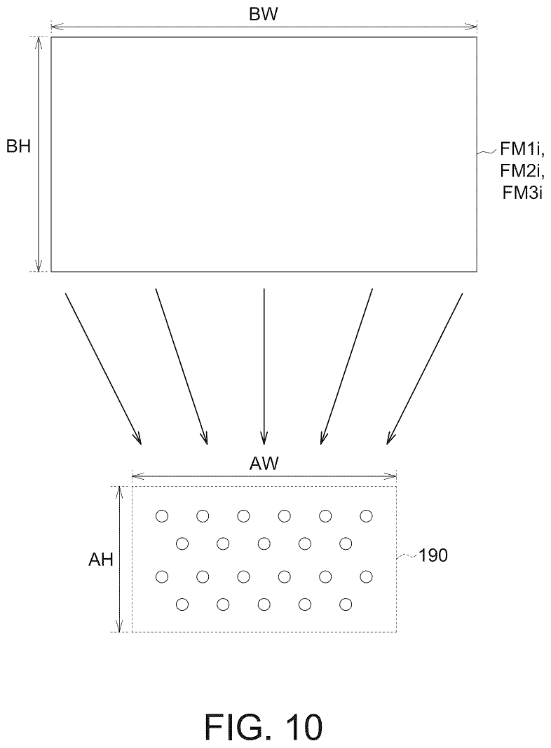

Refer to FIGS. 9A to 9B and FIG. 10 at the same time. FIGS. 9A to 9B is a detailed flowchart of step S130 according to an embodiment of the present disclosure. FIG. 10 illustrates each step of FIGS. 9A to 9B. In the present embodiment, step S130 detailed process of includes step S131 to S138. In step S131, the width AW and the height AH of the dynamic lighting effect device 190 are obtained by the lighting effect runtime unit 160.

Then, the method proceeds to step S132, the width BW and the height BH of the lighting effect tracking frame FM1i, the dynamic lighting effect frame FM2i or the predefined lighting effect frame FM3i are obtained by the lighting effect runtime unit 160.

Then, the method proceeds to step S133, whether the width AW of the dynamic lighting effect device 190 is greater than the width BW of the lighting effect tracking frame FM1i, the dynamic lighting effect frame FM2i or the predefined lighting effect frame FM3i is determined by the lighting effect runtime unit 160.

If the width AW of the dynamic lighting effect device 190 is greater than the width BW of the lighting effect tracking frame FM1i, the dynamic lighting effect frame FM2i or the predefined lighting effect frame FM3i, then the method proceeds to step S134. In step S134, interpolation is performed by the lighting effect runtime unit 160 on the lighting effect tracking frame FM1i, the dynamic lighting effect frame FM2i or the predefined lighting effect frame FM3i to amplify the width BW of the lighting effect tracking frame FM1i, the dynamic lighting effect frame FM2i or the predefined lighting effect frame FM3i.

If the width AW of the dynamic lighting effect device 190 is less than the width BW of the lighting effect tracking frame FM1i, the dynamic lighting effect frame FM2i or the predefined lighting effect frame FM3i, then the method proceeds to step S135. In step S135, pixel selection is performed on the lighting effect tracking frame FM1i, the dynamic lighting effect frame FM2i or the predefined lighting effect frame FM3i by the lighting effect runtime unit 160 to reduce the width BW of the lighting effect tracking frame FM1i, the dynamic lighting effect frame FM2i or the predefined lighting effect frame FM3i.

Then, the method proceeds to step S136, whether the height AH of the dynamic lighting effect device 190 is greater than the height BH of the lighting effect tracking frame FM1i, the dynamic lighting effect frame FM2i or the predefined lighting effect frame FM3i is determined by the lighting effect runtime unit 160.

If the height AH of the dynamic lighting effect device 190 is greater than the height BH of the lighting effect tracking frame FM1i, the dynamic lighting effect frame FM2i or the predefined lighting effect frame FM3i, then the method proceeds to step S137. In step S137, interpolation is performed on the lighting effect tracking frame FM1i, the dynamic lighting effect frame FM2i or the predefined lighting effect frame FM3i by the lighting effect runtime unit 160 to amplify the height BH of the lighting effect tracking frame FM1i, the dynamic lighting effect frame FM2i or the predefined lighting effect frame FM3i.

If the height AH of the dynamic lighting effect device 190 is less than the height BH of the lighting effect tracking frame FM1i, the dynamic lighting effect frame FM2i or the predefined lighting effect frame FM3i, then the method proceeds to step S138. In step S138, pixel selection is performed on the lighting effect tracking frame FM1i, the dynamic lighting effect frame FM2i or the predefined lighting effect frame FM3i by the lighting effect runtime unit 160 to reduce the height BH of the lighting effect tracking frame FM1i, the dynamic lighting effect frame FM2i or the predefined lighting effect frame FM3i.

According to the above embodiments, by using different methods for generating dynamic lighting effect, the user can switch among a diversity of lighting modes according to personal preference to generate different keyboard lighting effects to satisfy his/her experience with the keyboard lighting effect.

Different features of some implementations or examples for implementing the present disclosure are disclosed above. Specific examples (such as numerals or designations disclosed above) are used in the descriptions of elements and configurations to simplify/illustrate some implementations of the present disclosure. These elements and configurations are exemplified for explanatory purpose only, not for limiting the scope of protection. Besides, some implementations of the present disclosure can repeat reference symbols and/or letters in various examples. The said repetition is for the purpose of simplicity and clarity, and does not specify the relationship among various implementations and/or configurations.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. An electronic device with dynamic lighting effect, comprising:
an AI interactive unit, used to provide a lighting effect tracking frame according to an eye position of a user;
a self-defined lighting effect unit, used to receive a dynamic lighting effect frame;
a predefined lighting effect unit, used to store a predefined lighting effect frame;
a real-time lighting effect handler, connected to the AI interactive unit and the self-defined lighting effect unit to obtain the lighting effect tracking frame or the dynamic lighting effect frame;
a static lighting effect handler, connected to the predefined lighting effect unit to obtain the predefined lighting effect frame;
a lighting effect runtime unit, connected to the real-time lighting effect handler and the static lighting effect handler to perform a size adjustment procedure on the lighting effect tracking frame, the dynamic lighting effect frame or the predefined lighting effect frame to obtain a lighting effect control map;
a lighting effect applications interface unit, connected to the lighting effect runtime unit to obtain the lighting effect control map;
an HID control unit, used to obtain the lighting effect control map from the lighting effect applications interface unit; and
a dynamic lighting effect device, wherein the HID control unit outputs a control signal to the dynamic lighting effect device according to the lighting effect control map to generate the dynamic lighting effect.

2. The electronic device with the dynamic lighting effect according to claim 1, wherein the AI interactive unit obtains the eye position of the user, then generates the lighting effect tracking frame with a first color and a second color according to the eye position; the first color corresponds to the eye position.

3. The electronic device with the dynamic lighting effect according to claim 1, wherein if the AI interactive unit generates the lighting effect tracking frame, then the AI interactive unit stores the lighting effect tracking frame to a shared memory, and notifies the real-time lighting effect handler to retrieve the lighting effect tracking frame from the shared memory.

4. The electronic device with the dynamic lighting effect according to claim 1, wherein if the self-defined lighting effect unit receives the dynamic lighting effect frame, then the self-defined lighting effect unit stores the dynamic lighting effect frame to a shared memory, and notifies the real-time lighting effect handler to retrieve the dynamic lighting effect frame from the shared memory according to a sampling interval.

5. The electronic device with the dynamic lighting effect according to claim 1, wherein the predefined lighting effect unit stores the predefined lighting effect frame to a shared memory, and notifies the static lighting effect handler to retrieve the predefined lighting effect frame from the shared memory according to a sampling interval.

6. The electronic device with the dynamic lighting effect according to claim 1, wherein the lighting effect runtime unit performs a width adjustment procedure on a width of the lighting effect tracking frame, the dynamic lighting effect frame or the predefined lighting effect frame, and performs a height adjustment procedure on a height of the lighting effect tracking frame, the dynamic lighting effect frame or the predefined lighting effect frame.

7. The electronic device with the dynamic lighting effect according to claim 1, wherein the lighting effect runtime unit performs interpolation on the lighting effect tracking frame, the dynamic lighting effect frame or the predefined lighting effect frame to amplify width or height.

8. The electronic device with the dynamic lighting effect according to claim 1, wherein
the lighting effect runtime unit performs pixel selection on the lighting effect tracking frame, the dynamic lighting effect frame or the predefined lighting effect frame to reduce width or height.

9. The electronic device with the dynamic lighting effect according to claim 1, wherein the dynamic lighting effect frame is a dynamic frame obtained from Internet in real time.

10. The electronic device with the dynamic lighting effect according to claim 1, wherein the predefined lighting effect frame is a dynamic frame with fixed length.

11. A method for generating dynamic lighting effect, comprising:
providing a lighting effect tracking frame, receiving a dynamic lighting effect frame, or storing a predefined lighting effect frame according to an eye position of a user;
obtaining the lighting effect tracking frame, the dynamic lighting effect frame or the predefined lighting effect frame;
performing a size adjustment procedure on the lighting effect tracking frame, the dynamic lighting effect frame or the predefined lighting effect frame to obtain a lighting effect control map; and
controlling a dynamic lighting effect device according to the lighting effect control map to generate the dynamic lighting effect.

12. The method for generating the dynamic lighting effect according to claim 11, wherein in the step of providing the lighting effect tracking frame, the lighting effect tracking frame with a first color and a second color is generated according to the eye position; the first color corresponds to the eye position.

13. The method for generating the dynamic lighting effect according to claim 11, wherein the lighting effect tracking frame is stored in a shared memory, and a real-time lighting effect handler is notified to retrieve the lighting effect tracking frame from the shared memory.

14. The method for generating the dynamic lighting effect according to claim 11, wherein the dynamic lighting effect frame is stored in a shared memory, and a real-time lighting effect handler is notified to retrieve the dynamic lighting effect frame from the shared memory according to a sampling interval.

15. The method for generating the dynamic lighting effect according to claim 11, wherein the predefined lighting effect frame is stored in a shared memory, and a static lighting effect handler is notified to retrieve the dynamic lighting effect frame from the shared memory according to a sampling interval.

16. The method for generating the dynamic lighting effect according to claim 11, wherein in the step of performing the size adjustment procedure on the lighting effect tracking frame, the dynamic lighting effect frame or the predefined lighting effect frame, a width adjustment procedure is performed on a width of the lighting effect tracking frame, the dynamic lighting effect frame or the predefined lighting effect frame, and a height adjustment procedure is performed on a height of the lighting effect tracking frame, the dynamic lighting effect frame or the predefined lighting effect frame.

17. The method for generating the dynamic lighting effect according to claim 11, wherein in the step of performing the size adjustment procedure on the lighting effect tracking frame, the dynamic lighting effect frame or the predefined lighting effect frame, interpolation is performed on the lighting effect tracking frame, the dynamic lighting effect frame or the predefined lighting effect frame to amplify width or height.

18. The method for generating the dynamic lighting effect according to claim 11, wherein in the step of performing the size adjustment procedure on the lighting effect tracking frame, the dynamic lighting effect frame or the predefined lighting effect frame, pixel selection is performed on the lighting effect tracking frame, the dynamic lighting effect frame or the predefined lighting effect frame to reduce width or height.

19. The method for generating the dynamic lighting effect according to claim 11, wherein the dynamic lighting effect frame is dynamic frame obtained from Internet in real time.

20. The method for generating the dynamic lighting effect according to claim 11, wherein the predefined lighting effect frame is a dynamic frame with fixed length.
